(19) United States
(12) Patent Application Publication
(10) Pub. No.: US 2025/0388151 A1
(43) Pub. Date: Dec. 25, 2025

(54) SEATBACK

(71) Applicant: TOYOTA BOSHOKU KABUSHIKI KAISHA, Aichi (JP)

(72) Inventors: Junpei SATO, Aichi (JP); Kimiyasu KUROKAWA, Gifu (JP)

(73) Assignee: TOYOTA BOSHOKU KABUSHIKI KAISHA, Aichi (JP)

(21) Appl. No.: 19/241,956

(22) Filed: Jun. 18, 2025

(30) Foreign Application Priority Data
Jun. 21, 2024 (JP) 2024-100265

(51) Int. Cl. B60N 2/68

(52) U.S. Cl. CPC B60N 2/686; B60N 2/682; B60N 2/688

(57) ABSTRACT

One aspect of the present disclosure provides a seatback including a back frame, a fixed portion, a first coupled portion, a second coupled portion, a first diagonal bead portion, and a second diagonal bead portion. The first diagonal bead portion (i) is raised from a surface of a back panel of the back frame in a thickness direction thereof and (ii) extends in a diagonal direction inclined relative to a seat width direction and a seat up-down direction. The second diagonal bead portion (i) is provided at a diagonal position relative to the first diagonal bead portion on the back panel, (ii) is raised from the surface of the back panel in the thickness direction thereof, and (iii) extends in the diagonal direction.

### CROSS-REFERENCE TO RELATED APPLICATIONS

This application claims the benefit of Japanese Patent Application No. 2024-100265 filed on Jun. 21, 2024 with the Japan Patent Office, the entire disclosure of which is incorporated herein by reference.

### BACKGROUND

The present disclosure relates to a seatback for a vehicle seat.

Japanese Unexamined Patent Application Publication No. 2015-074390 discloses a seatback in which an upper part of one side of the seatback in width direction thereof is fixed to a vehicle, and a lower part of the one side and a lower part of the opposite side of the seatback in the width direction thereof are rotatably coupled to the vehicle. In other words, such a seatback is coupled to the vehicle at only three portions of its four corners.

### SUMMARY

In the seatback coupled to the vehicle at the three portions, a portion uncoupled to the vehicle may be significantly displaced when an external force is applied on the seatback in a front-rear direction of the vehicle.

In one aspect of the present disclosure, it is desirable to provide a seatback that can inhibit its portion uncoupled to a vehicle from being significantly displaced when an external force is applied on the seatback in a front-rear direction of the vehicle.

One aspect of the present disclosure may provide a seatback for a vehicle seat that comprises at least any one of:
Feature 1: a back frame (i) including a back panel in the form of a substantially rectangular plate and (ii) forming a framework of the seatback;
Feature 2: a fixed portion (i) provided at an upper part of a first side of the back frame in a width direction thereof and (ii) configured to be fixed to a vehicle;
Feature 3: a first coupled portion and a second coupled portion (i) respectively provided at a lower part of the first side and a lower part of a second side of the back frame in the width direction thereof and (ii) configured to be rotatably coupled to the vehicle, the second side being positioned opposite to the first side;
Feature 4: a first diagonal bead portion (i) in the form of an elongated protrusion, (ii) positioned close to the fixed portion on the back panel, (iii) raised from a surface of the back panel in a thickness direction thereof, and (iv) extending in a diagonal direction inclined relative to a seat width direction and a seat up-down direction; and
Feature 5: a second diagonal bead portion (i) in the form of an elongated protrusion, (ii) provided at a diagonal position relative to the first diagonal bead portion on the back panel, (iii) raised from the surface of the back panel in the thickness direction thereof, and (iv) extending in the diagonal direction.

The seatback comprising at least Features 1 through 5 can inhibit its portion uncoupled to the vehicle from being significantly displaced in a front-rear direction of the vehicle even when an external force is applied on the seatback in the front-rear direction.

Specifically, in the seatback, displacements of the fixed portion, the first coupled portion, and the second coupled portion are restricted by the vehicle, while displacement of the portion uncoupled to the vehicle (hereinafter referred to as free portion) is not restricted by the vehicle.

For this reason, when the external force is applied on the seatback in the front-rear direction, the free portion tends to displace in a direction of the external force such that an imaginary line connecting the fixed portion with the coupled portion positioned diagonally to the fixed portion (for example, the second coupled portion) becomes a neutral line.

In contrast, the back panel is provided with the first diagonal bead portion and the second diagonal bead portion, thereby making it possible to reduce deformation of the back panel that would cause the imaginary line to become the neutral line. Consequently, in the seatback, it is possible to inhibit the free portion from being significantly displaced in the direction of the external force.

The seatback may comprise, in addition to or in place of at least any one of Feature 1 through 5,
Feature 6: the back panel comprises two or more vertical bead portions each of which is in the form of an elongated protrusion (i) raised from the surface of the back panel in the thickness direction and (ii) extending in the seat up-down direction.

In the seatback comprising at least Features 1 through 6, the rigidity of the back panel can be increased.

The seatback may comprise, in addition to or in place of at least any one of Features 1 through 6, at least any one of:
Feature 7: a mounting portion (i) provided on the back panel and (ii) configured such that a retractor for winding up a webbing of a seat belt is mounted thereon;
Feature 8: a beam (i) joined to an upper side of the back panel and (ii) extending in the seat width direction;
Feature 9: a receiving part (i) provided on the beam and (ii) configured to receive a tensile force applied to the webbing; and
Feature 10: at least one of the two or more vertical bead portions adjacent to the mounting portion extends to a location overlapped by the beam.

In the seatback comprising at least Features 1 through 10, it is possible to secure a necessary rigidity around the receiving part.

### BRIEF DESCRIPTION OF THE DRAWINGS

An example embodiment of the present disclosure will be described hereinafter with reference to the accompanying drawings, in which:

FIG. 1 shows a seatback according to a first embodiment;

FIG. 2 is an exploded view of a back frame according to the first embodiment;

FIG. 3 shows a panel body according to the first embodiment;

FIG. 4 shows a curled portion according to the first embodiment;

FIG. 5 shows an enclosure frame according to the first embodiment; and

FIG. 6 shows the back frame according to the first embodiment with an imaginary line.

### DETAILED DESCRIPTION OF EXEMPLARY EMBODIMENTS

The embodiments below show examples of embodiments that fall within the technical scope of the present disclosure. The appended claims are not limited to any specific configuration, structure, or the like described in the following embodiments.

The embodiments show examples where a seatback according to the present disclosure is applied to a seat to be mounted in a vehicle, such as an automobile (hereinafter referred to as “vehicle seat”). Arrows for indicating directions, oblique lines, or the like in each drawing are provided to facilitate understanding of mutual relations between the drawings, and the shapes of members or portions, and the like.

Thus, the seatback is not limited to be oriented as shown in each drawing. A drawing with oblique lines does not necessarily represent a cross-sectional view.

With respect at least to a member or a portion explained with a reference numeral, at least one such member or portion is provided unless it is specified using a term such as “only one”. Unless it is specified using a term such as “only one”, two or more of such members or portions may be provided. The seatback disclosed in the present disclosure includes at least one element, such as a member or a portion explained with a reference numeral, or a structural component shown in the drawings.

### First Embodiment

### <1. Overview of Seatback>

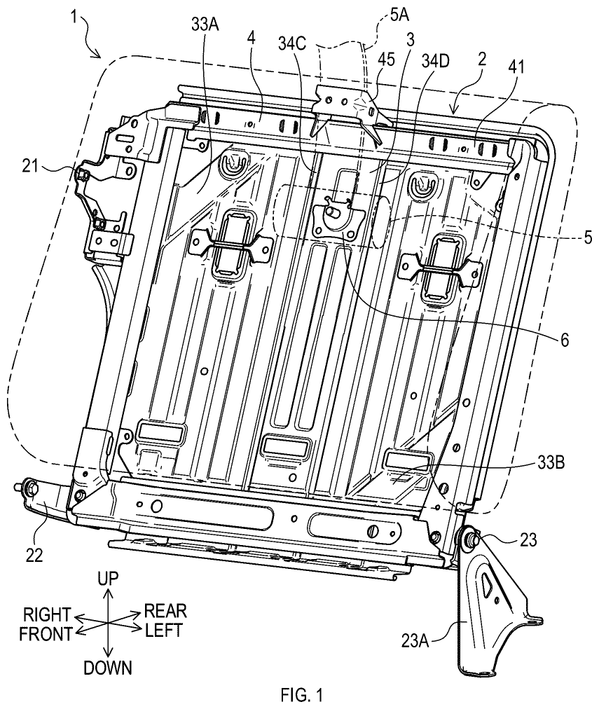

A seatback 1 according to the present embodiment is a seatback to be used for a rear seat of a vehicle, as shown in FIG. 1. The seatback 1 is configured to support the back of an occupant. The seatback 1 comprises a back frame 2, a cushion (not shown), an outer cover (not shown), and the like.

The back frame 2 is a strength member that forms a framework of the seatback 1. The cushion is a shock-absorbing member made of foamed urethane or the like. The outer cover is a cover that covers the cushion and the back frame 2.

The back frame 2 comprises a fixed portion 21, a first coupled portion 22, and a second coupled portion 23. The fixed portion 21 is a portion to be fixed to the vehicle and provided at an upper part of one side of the back frame 2 in a width direction thereof (i.e., an upper right side in the present embodiment).

Specifically, the fixed portion 21 is where a latch device (not shown) is to be mounted. The latch device is configured to be engaged with a striker (not shown) in the vehicle. The latch device can be switched between an engaged state and a disengaged state. In the engaged state, the latch device is engaged with the striker. In the disengaged state, the latch device is disengaged from the striker.

The first coupled portion 22 and the second coupled portion 23 are configured to be rotatably coupled to the vehicle. The first coupled portion 22 is provided at a lower part of the one side of the back frame 2 in the width direction thereof (i.e., a lower right side in the present embodiment).

The second coupled portion 23 is provided at a lower part of the opposite side of the back frame 2 in the width direction thereof (i.e., a lower left side in the present embodiment). The second coupled portion 23 is configured to be coupled to the vehicle via a bracket 23A.

In the engaged state where the latch device is engaged with the striker, the seatback 1 is held in the vehicle in a standing manner as shown in FIG. 1. When the latch device is disengaged from the striker, the seatback 1 becomes rotatable about the first coupled portion 22 and the second coupled portion 23 so as to be tilted forward.

### <2. Configuration of Back Frame>

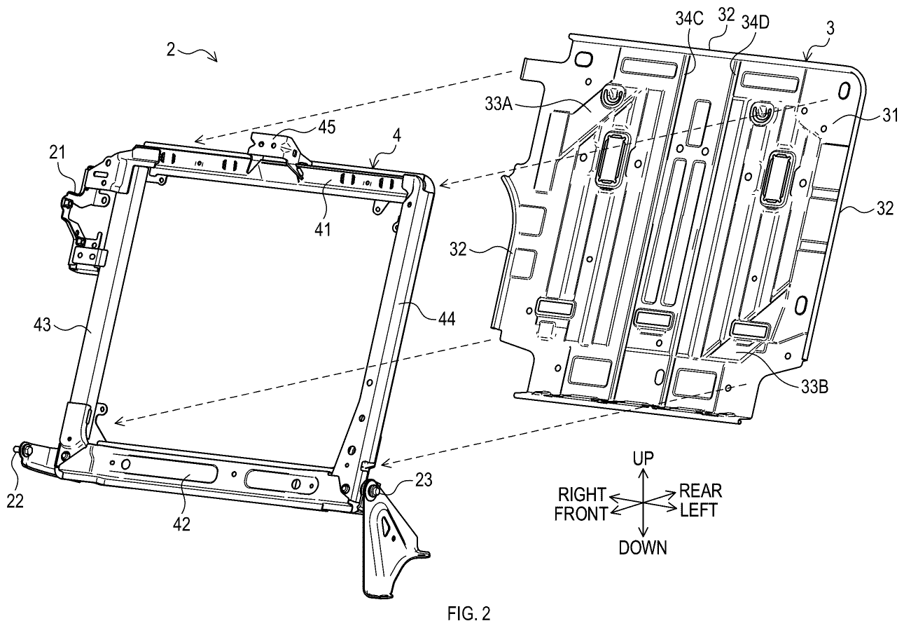

As shown in FIG. 2, the back frame 2 comprises at least a back panel 3 and an enclosure frame 4. The back panel 3 is a metal panel in the form of a substantially rectangular plate. The enclosure frame 4 is a metal framework in the form of a rectangular frame. The enclosure frame 4 is joined to the back panel 3 (to be precise, to a panel body 31, which is described below) by welding.

### <2.1 Details of Back Panel>

The back panel 3 comprises at least the panel body 31 and a curled portion 32. In the present embodiment, the panel body 31 (including bead portions 33 and 34 to be described below) and the curled portion 32 are portions of a single metal plate plastically deformed.

### <Panel Body>

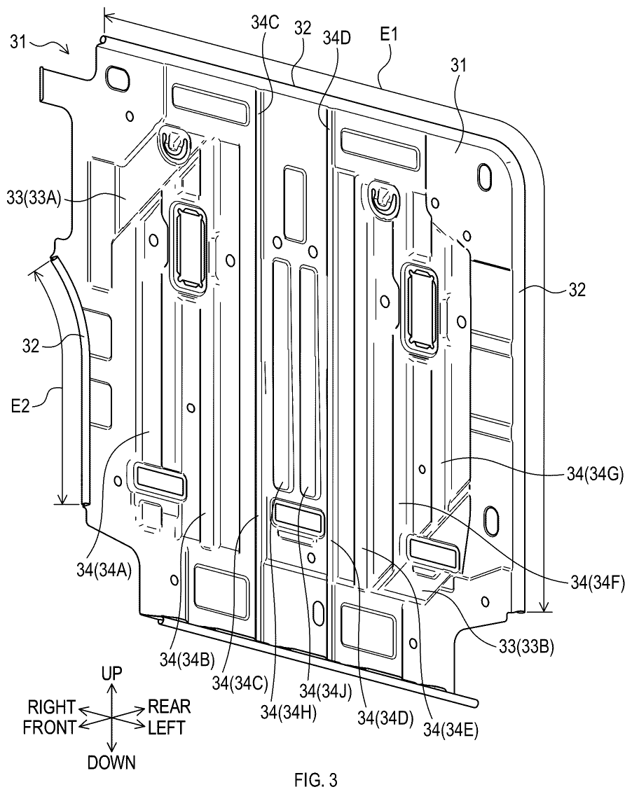

As shown in FIG. 3, the panel body 31 is a portion in the form of a substantially rectangular plate provided with bead portions 33 and 34. Each of the bead portions 33 and 34 is in the form of an elongated protrusion raised in a direction along the thickness of the panel body 31 from a surface of the panel body 31.

The bead portions 33 includes a first diagonal bead portion 33A and a second diagonal bead portion 33B. As shown in FIG. 1, the first diagonal bead portion 33A is positioned close to the fixed portion 21 on the panel body 31, that is the back panel 3, and in the form of an elongated protrusion extending in a diagonal direction inclined relative to a seat width direction and a seat up-down direction.

The second diagonal bead portion 33B is provided at a diagonal position relative to the first diagonal bead portion 33A on the panel body 31, that is the back panel 3, and is in the form of an elongated protrusion extending in the diagonal direction.

In other words, the first diagonal bead portion 33A is a brace-like bead portion that connects an upper end side of the back panel 3 and a right end side of the back panel 3 to each other. The second diagonal bead portion 33B is a brace-like bead portion that connects a lower end side of the back panel 3 and a left end side of the back panel 3 to each other.

The bead portions 34 includes vertical bead portions 34A through 34H and 34J, each of which is in the form of an elongated protrusion extending in the seat up-down direction. The vertical bead portions 34A through 34H and 34J extend in a vehicle front-rear direction, when viewed in a tilted-down state of the seatback 1.

The panel body 31, that is the back panel 3, according to the present embodiment is provided with a mounting portion 6 (see FIG. 1) to which a retractor 5 is to be mounted. The retractor 5 is a device configured to wind up a seat belt webbing (belt portion) 5A.

Out of the vertical bead portions 34A through 34 H and 34J, the vertical bead portions 34C and 34D adjacent to the mounting portion 6 extend to the respective positions to be overlapped by the upper beam 41, which is described below. Specifically, as shown in FIG. 3, the vertical bead portions 34C and 34D extend to the upper edge of the panel body 31.

The vertical bead portions 34C and 34D extend at least from a portion of the panel body 31 lower than a lower end of the mounting portion 6 to the upper edge of the panel body 31. The vertical bead portions 34C and 34D according to the present embodiment extend from the lower edge to the upper edge of the panel body 31.

### <Curled Portion>

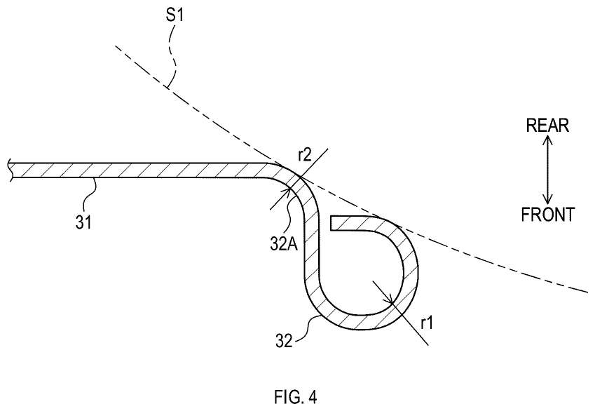

As shown in FIG. 4, the curled portion 32 is a portion in which the outer edge of the panel body 31 curved in an arc shape. The phrase of “curved in an arc shape” mentioned immediately before refers to a structure in which the angle of the arc is, for example, 180 degrees or greater (270 degrees or greater, in the present embodiment).

As shown in FIG. 3, the curled portion 32 is provided at at least a part of the outer edge of the panel body 31 (at the outer edges E1 and E2, in the present embodiment). As shown in FIG. 4, the entire curled portion 32 is arranged at a position displaced in a seat front-rear direction (deviates in the forward direction, in the present embodiment) from an imaginary line extending from the panel body 31.

The curled portion 32 and the panel body 31 are connected via a connecting portion 32A. The connecting portion 32A is curved in an arc shape. A hypothetical tangent circle S1 tangent to the curled portion 32 and the connecting portion 32A has a radius larger than a radius of curvature r1 of the curled portion 32 and a radius of curvature r2 of the connecting portion 32A.

### <2.2 Details of Enclosure Frame>

As shown in FIG. 2, the enclosure frame 4 is in the form of a rectangular frame extending along the outer edge of the panel body 31. Specifically, the enclosure frame comprises the upper beam 41, a lower beam 42, a first side frame 43, a second side frame 44.

The upper beam 41 is a frame joined to the upper side of the back panel 3, namely the upper side of the panel body 31, and extending in the seat-width direction. The upper beam 41 is provided with a receiving part 45. As shown in FIG. 1, the receiving part 45 is configured to receive a tensile force applied to the webbing 5A.

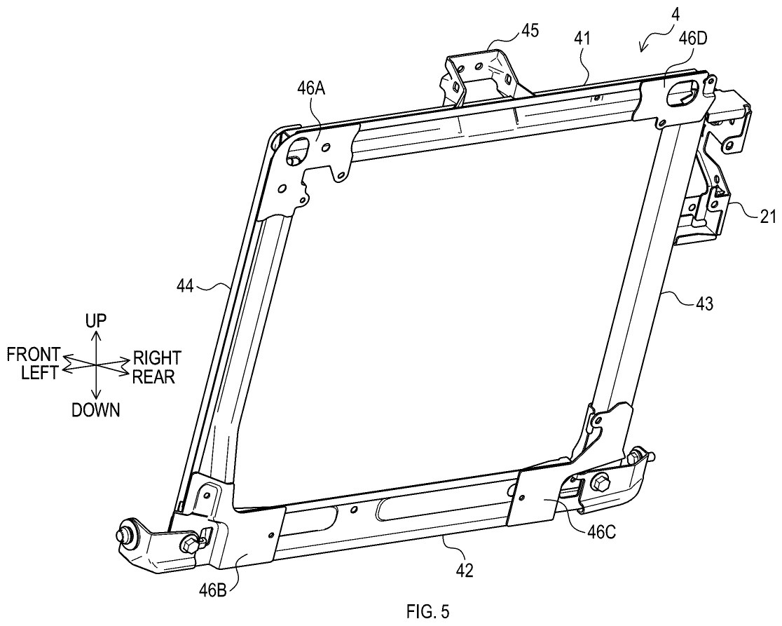

As shown in FIG. 5, the receiving part 45 according to the present embodiment forms, together with the upper beam 41, a rectangular closed curve frame portion into which the webbing 5A is to be inserted. The tensile force applied to the receiving part 45 is transmitted to the back frame 2 via the upper beam 41.

As shown in FIG. 2, the lower beam 42 is a frame joined to a lower side of the panel body 31 and extending in the seat-width direction. The first side frame 43 and the second side frame 44 are coupled to the respective ends of the upper beam 41 in its extending direction and the respective ends of the lower beam 42 in its extending directions.

As shown in FIG. 5, gusset plates 46A through 46D are joined to a portion where the upper beam 41 and the second side frame 44 are connected, a portion where the lower beam 42 and the second side frame 44 are connected, a portion where the lower beam 42 and the first side frame 43 are connected, and a portion where the upper beam 41 and the first side frame 43 are connected, respectively. The gusset plates 46A through 46D are reinforcing plates that reinforce the connections.

In the present embodiment, each of the upper beam 41, the lower beam 42, and the second side frame 44 has a substantially C-shape cross-section or a substantially angular C-shape cross-section that is open in its rear side. The opening in each cross-section is closed with the panel body 31.

The first side frame 43 has a cross-section that independently forms a closed rectangular shape. This is because the fixed portion 21 is arranged on the first side frame 43. The panel body 31 according to the present embodiment is also joined to a rear surface of the first side frame 43.

### <3. Features of Seatback of Present Embodiment>

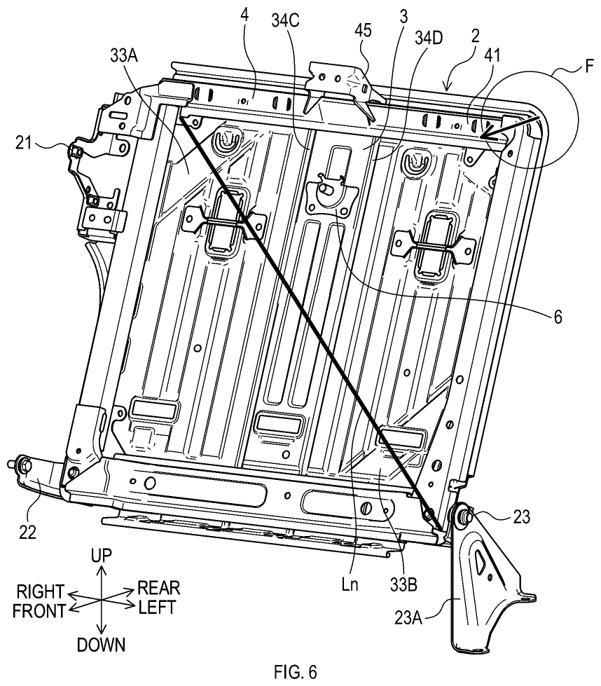

In the back frame 2 according to the present embodiment, displacements of the fixed portion 21, the first coupled portion 22, and the second coupled portion 23 are restricted by the vehicle, while displacements of a portion uncoupled to the vehicle (hereinafter referred to as a free portion F, see FIG. 6) are not restricted by the vehicle.

For this reason, when an external force is applied to the seatback 1 in the front-rear direction of the vehicle, as shown in FIG. 6, the free portion F tends to displace in a direction of the external force such that an imaginary line Ln connecting the fixed portion 21 with the second coupled portion 23 positioned diagonally to the fixed portion 21 becomes a neutral line.

In contrast, the back panel 3 of the back frame 2 is provided with the first diagonal bead portion 33A and the second diagonal bead portion 33B, thereby making it possible to reduce deformation of the back panel 3 that would cause the imaginary line Ln to become the neutral line. Consequently, in the back frame 2, it is possible to inhibit the free portion F from being significantly displaced in the direction of the external force.

The back panel 3 is provided with the vertical bead portions 34A through 34H and 34J, and the vertical bead portions 34A through 34H and 34J are in the form of the elongated protrusions raised from the surface of the back panel 3 in the thickness direction thereof and extending in the seat up-down direction. This can increase the rigidity of the back panel 3.

In addition, when the seatback 1 is tilted forward into a flat position and then used as a part of a luggage space, the vertical bead portions 34A through 34H and 34J extend in the front-rear direction of the vehicle. Accordingly, a user can easily slide cargo placed in the luggage space in the front-rear direction of the vehicle on the vertical bead portions 34A through 34H and 34J.

If the bead portions were formed to extend in the seat-width direction, the cargo placed in the luggage space would be caught by the bead portions when slid in the front-rear direction of the vehicle, making it difficult for the user to easily slide the cargo in the front-rear direction of the vehicle.

Out of the vertical bead portions 34A through 34H and 34J, the vertical bead portions 34C and 34D adjacent to the mounting portion 6 extend to the respective locations overlapped by the upper beam 41. This configuration makes it possible to secure a necessary rigidity around the receiving part 45.

### Other Embodiments

In the aforementioned embodiment, the panel body 31 is provided with the curled portion 32. However, the present disclosure is not limited thereto. Specifically, the present disclosure may include a configuration in which the curled portion 32 is eliminated, for example.

The curled portion 32 according to the aforementioned embodiment is formed to be located on a front side relative to the panel body 31. However, the present disclosure is not limited thereto. Specifically, the present disclosure may include, for example, a configuration in which the curled portion 32 is formed to be located on a rear side relative to the panel body 31, or a configuration in which a center of the curled portion 32 is located on an extension of the panel body 31.

In the aforementioned embodiment, the panel body 31 is provided with the bead portions 33 and 34. However, the respective configurations of the bead portions 33 and 34 according to the present disclosure, such as the respective positions and the respective extending directions of the bead portions 33 and 34, are not limited to the configurations shown in the figures such as FIG. 1.

In the aforementioned embodiments, the vehicle seat of the present disclosure is mounted in the automobile. However, the present disclosure is not limited to this configuration. The present disclosure may be applied to a seat used in a vehicle such as a railroad vehicle, a ship, a boat, or an aircraft, or to a stationary seat used in a theater or a household, for example.

Furthermore, the present disclosure is not limited to the aforementioned embodiments as long as it falls within the spirit of the disclosure described in the aforementioned embodiments. Accordingly, at least two of the aforementioned embodiments may be combined, or some of the elements shown in the drawings or described with reference to assigned reference numerals in the aforementioned embodiments may be eliminated.

What is claimed is:

1. A seatback for a vehicle seat, the seatback comprising:
a back frame (i) including a back panel in the form of a substantially rectangular plate and (ii) forming a framework of the seatback;
a fixed portion (i) provided at an upper part of a first side of the back frame in a width direction thereof and (ii) configured to be fixed to a vehicle;
a first coupled portion and a second coupled portion (i) respectively provided at a lower part of the first side and a lower part of a second side of the back frame in the width direction thereof and (ii) configured to be rotatably coupled to the vehicle, the second side being positioned opposite to the first side;
a first diagonal bead portion (i) in the form of an elongated protrusion, (ii) positioned close to the fixed portion on the back panel, (iii) raised from a surface of the back panel in a thickness direction thereof, and (iv) extending in a diagonal direction inclined relative to a seat width direction and a seat up-down direction; and
a second diagonal bead portion (i) in the form of an elongated protrusion, (ii) provided at a diagonal position relative to the first diagonal bead portion on the back panel, (iii) raised from the surface of the back panel in the thickness direction thereof, and (iv) extending in the diagonal direction.

2. The seatback according to claim 1,
wherein the back panel comprises two or more vertical bead portions each of which is in the form of an elongated protrusion (i) raised from the surface of the back panel in the thickness direction thereof and (ii) extending in the seat up-down direction.

3. The seatback according to claim 2, further comprising:
a mounting portion (i) provided on the back panel and (ii) configured such that a retractor for winding up a webbing of a seat belt is mounted thereon;
a beam (i) joined to an upper side of the back panel and (ii) extending in the seat width direction; and
a receiving part (i) provided on the beam and (ii) configured to receive a tensile force applied to the webbing,
wherein at least one of the two or more vertical bead portions adjacent to the mounting portion extends to a location overlapped by the beam.
